(19) United States
(12) Patent Application Publication
(10) Pub. No.: US 2013/0090833 A1
(43) Pub. Date: Apr. 11, 2013

(54) ENGINE SYNCHRONIZATION METHOD

(71) Applicants: Jérôme LACHAIZE, Toulouse (FR); Pierre ZOUBOFF, Toulouse (FR)

(72) Inventors: Jérôme LACHAIZE, Toulouse (FR); Pierre ZOUBOFF, Toulouse (FR)

(73) Assignees: CONTINENTAL AUTOMOTIVE GMBH, Hannover (DE); CONTINENTAL AUTOMOTIVE FRANCE, Toulouse (FR)

(21) Appl. No.: 13/616,113

(22) Filed: Sep. 14, 2012

(30) Foreign Application Priority Data
Oct. 5, 2011 (FR) 1103021

(51) Int. Cl. F02D 45/00

(52) U.S. Cl. 701/102

(57) ABSTRACT

A method for synchronizing an internal combustion engine having at least one cylinder including a piston moving between a top and a bottom dead center, the movement driving a crank shaft and a cam shaft, the method including:
determining as many plausible hypotheses as there are reference teeth present on the target attached to the crank shaft in two crank shaft revolutions,
detecting the passing of reference edges of a target attached to the crank shaft and of rising or falling edges of a target attached to the cam shaft,
using the positioning of detected edges to eliminate one or more hypotheses made for the position of the top dead center of the cylinder at start up, by comparing the positioning of detected edges with a positioning of the edges corresponding to the determined hypotheses, and terminating synchronization when all hypotheses except one have been eliminated.

The present invention relates generally to the operation of internal combustion engines and, more specifically, the synchronization of such engines.

Synchronizing an internal combustion engine entails accurately identifying the position of the moving parts (piston, crank shaft, cam shaft, etc.) as well as the instant of the engine cycle (whether the latter is a 2-stroke or 4-stroke type engine) in order to enable the onboard electronics to manage said engine with the precision and accuracy required for its correct operation.

Synchronization methods are known which implement algorithms that make it possible to determine the position of an engine as a function of the position of a crank shaft and of a cam shaft, detected by sensors installed in the engine. Said sensors cooperate with toothed targets attached in rotation to said crank shaft and cam shafts.

These algorithms work, for example, as follows:
upon initialization of the algorithm, the angular position of the crank shaft is considered to be included within an interval contained within an engine cycle (ranging from 0° to 720° for a 4-stroke type engine),
the engine is started up, and each time an event is detected, the algorithm reduces the initial interval, on the basis of predetermined relationships, explained hereinbelow,
after a certain number of events have been detected, the interval is reduced to a single value, corresponding to the initial position of the crank shaft, and it is then possible to synchronize the engine.

As indicated, for 4-stroke type engines, such algorithms apply hypotheses and predetermined relationships, notably between the edges detected on the target attached to the crank shaft and the edges detected on the target attached to the cam shaft. For example, if the cam shaft present in the engine includes a toothed target provided with N teeth, it is possible to take as starting hypothesis that the position of the cam shaft is situated between the edge 0 and the edge N of the teeth of the target. Then, each time an event is detected, which may be the passing of a tooth edge of the target attached to the crank shaft, or of a tooth edge of the target attached to the cam shaft, the possibilities are reduced. In fact, the angular positionings of the different tooth edges of the target attached to the cam shaft are not regular, and are known. The tooth edges of the target attached to the crank shaft are, for their part, geometrically equidistant (apart from a succession of teeth eliminated so as to form a “reference tooth” on the target). Thus, by measuring the angular rotation (defined by the number of teeth detected on the target attached to the crank shaft) between a first edge and a second edge of the target attached to the cam shaft, it is possible to eliminate certain starting hypotheses. All these algorithms are therefore based on the detection of the edges of teeth of the target attached to the cam shaft and on the reconstruction of the unique form of said target. Once the target attached to the cam shaft is clearly identified, the position of the engine is possible since the cam shaft performs one revolution over the 4-stroke cycle; knowing the position of the cam shaft amounts to knowing the position of the engine in its engine cycle.

However, it has been found that such algorithms presented drawbacks, notably in the case where the angular distances between the edges of the target attached to the cam shaft, or between the reference tooth of the target attached to the crank shaft and the edges of the target attached to the cam shaft, are too small. In practice, upon the detection of the positions, a tolerance threshold is applied to take account of the inaccuracies of the sensors and of the mechanical inaccuracies. Thus, if the distances are too small, it is impossible to distinguish them from one another, since they appear equal, to within the tolerance threshold.

Furthermore, such algorithms cannot be used for the synchronization of an engine comprising a crank shaft whose target has a number of reference teeth that are not angularly equidistant, which is fairly commonplace.

In such situations, the prior art algorithms do not manage to synchronize the engine.

The present invention therefore aims to propose a synchronization method that makes it possible to remedy the abovementioned drawbacks.

The invention also aims to propose a method that can be implemented in any internal combustion engine configuration.

Additionally, the invention aims to propose a synchronization method that is faster than the existing methods.

To this end, the present invention proposes a synchronization method using starting hypotheses based on the position of one of the two top dead centers of the cylinder 0 of the engine, for example the compression top dead center, bearing in mind that a reference point on the crank shaft other than the top dead center could be appropriate. This position will hereinafter be denoted TDC0 (from the abbreviation “top dead center”). In practice, as is known, in a 4-stroke engine cycle, therefore comprising an intake stroke, a compression stroke, a combustion stroke, and an exhaust stroke, there are two top dead centers for a piston, one on compression and one on exhaust. The present invention uses starting hypotheses for the position of one of the top dead centers, according to choice.

Thus, more specifically, the invention relates to a method for synchronizing an internal combustion engine of 4-stroke type, comprising at least one cylinder comprising a piston that moves between a top dead center and a bottom dead center, the movement of the piston driving a crank shaft and a cam shaft, the method comprising the following steps:
as many plausible hypotheses as there are reference teeth present on the target attached to the crank shaft in two crank shaft revolutions are determined, concerning the position of one of the two top dead centers of the reference cylinder in the engine cycle at the moment of start up,
from the start up of the crank shaft, the passing of reference edges of a target attached to the crank shaft and of rising or falling edges of a target attached to the cam shaft is detected, each target being associated with a detector in order to produce position sensors for said crank shaft and cam shaft,
at a current position of the crank shaft from its start up, the positioning of the detected edges is used to eliminate one or more hypotheses made for the position of said top dead center of the cylinder at the moment of start up, by comparing the positioning of the detected edges with a positioning of the edges corresponding to the determined hypotheses, and
the synchronization is terminated when all the hypotheses except one have been eliminated.

In the context of the implementation of such a method, the detection of passing of the reference edges on the target attached to the crank shaft and of rising (or falling) edges on the target attached to the cam shaft is performed via sensors installed on the engine.

The principle of this method therefore consists in making hypotheses as to a plausible position of one determined top dead center of a cylinder out of the two possible, for example, preferentially, the compression top dead center, at the moment of start up, and using each detection of an edge of the target attached to the cam shaft to confirm or deny one or more of these hypotheses. Thus, it is no longer necessary to systematically wait for the detection of a unique combination of positive events of edges of the target of the crank shaft and of the target of the cam shaft, or to use a totally deterministic solution in order to synchronize the engine on start up.

The positioning of the edges of the target attached to the cam shaft and of the target attached to the crank shaft is known from the structure of these targets correlated by the distribution link, and stored, as is known, in the memory of the engine computer. The positioning of the edges corresponding to the determined hypotheses relating to the position of one of the two top dead centers of the reference cylinder is thus known from information stored in an electronic computer, for example the engine computer.

As for the reference edges detected on the target attached to the crank shaft, these are used to serve as a reference for the different measurements, determinations and comparisons performed.

Such a method makes it possible, unlike the previously known methods, to synchronize an engine in all the possible target configurations. This method is implemented via an electronic computer, for example the engine computer, and makes it possible to provide a robust solution.

In a particular embodiment of the invention, in light of the mechanical configuration of the engine and of the engine cycle, an initial list of probabilities of the edges detected on the target attached to the cam shaft is established, called CAM_PLAUS_LIST, for each hypothesis made for the position of said top dead center of the cylinder at the moment of start up.

Thus, in this list, the bit No. i represents the probability of the rising or falling edge i. The term “probability” here should be understood to mean an event which can take two plausible values, namely “true” or “false”.

This list will be updated during the method, while eliminating, after the different tests implemented, the edges that are not plausible.

Advantageously:
for each element of the list CAM_PLAUS_LIST, a determination is made as to whether, in the context of an engine cycle, a successive edge of the target attached to the cam shaft should occur before a reference edge of the target attached to the crank shaft,
in the case where the determination is negative, the corresponding element is deleted from the list CAM_PLAUS_LIST.

In another embodiment:
a reference edge is detected on the target attached to the crank shaft,
a number of plausible hypotheses concerning the position of said top dead center in the engine cycle at the moment of start up are determined,
for each of the hypotheses, the chronology of occurrence of the edges of the target attached to the cam shaft is determined, from the list CAM_PLAUS_LIST.

Thus, the list of the rising and falling edges detected on the target attached to the cam shaft is multiplied by the number of estimations on TDC0. The lists will then be updated for each hypothesis, and will be described later in the present application.

When a list is empty, this means that the associated TDC0 position, that is to say the corresponding hypothesis, is not plausible and must be eliminated.

When only a single TDC0 hypothesis remains plausible, the engine is synchronized.

In another embodiment:
for each of the plausible hypotheses concerning the position of said top dead center in the engine cycle at the moment of start up, a check is made as to whether an edge should have occurred between the last edge detected on the target attached to the cam shaft and the current position,
in the case where the check proves negative, the corresponding hypothesis is eliminated.

Advantageously, the edges observed on the targets are the rising edges.

The invention also covers a device for synchronizing an internal combustion engine of 4-stroke type implementing the method described above.

Other advantages and particular features of the present invention will emerge from the following description, given as a nonlimiting example and with reference to the appended drawings:

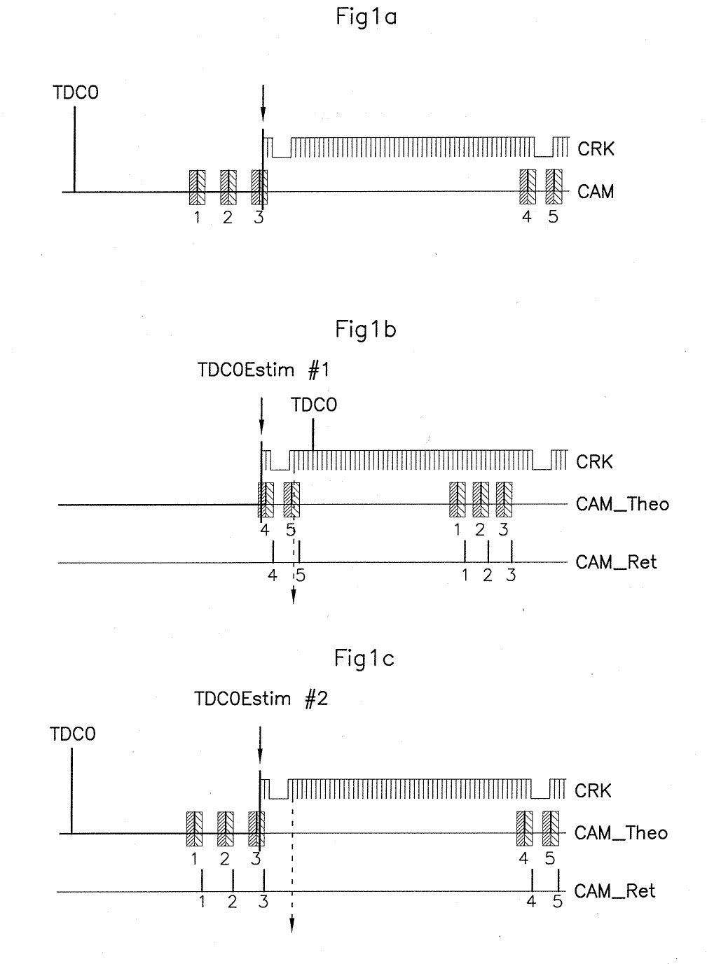

FIGS. 1a, 1b and 1c represent a first synchronization test implemented in a method according to the present invention,

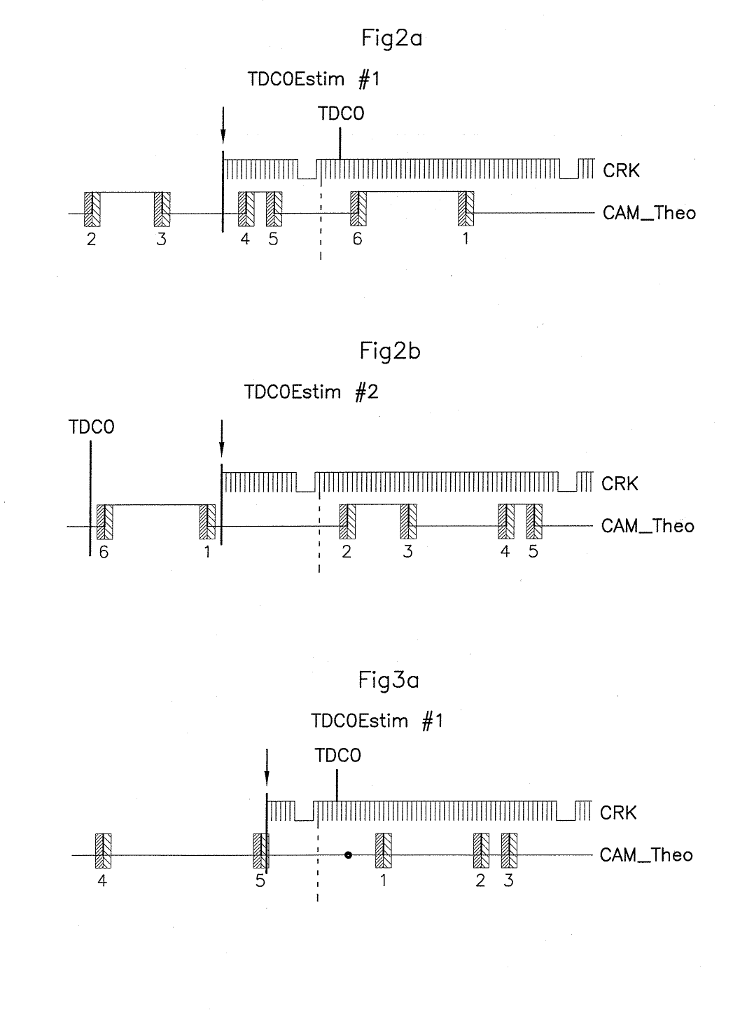

FIGS. 2a and 2b represent a second synchronization test implemented in a method according to the present invention,

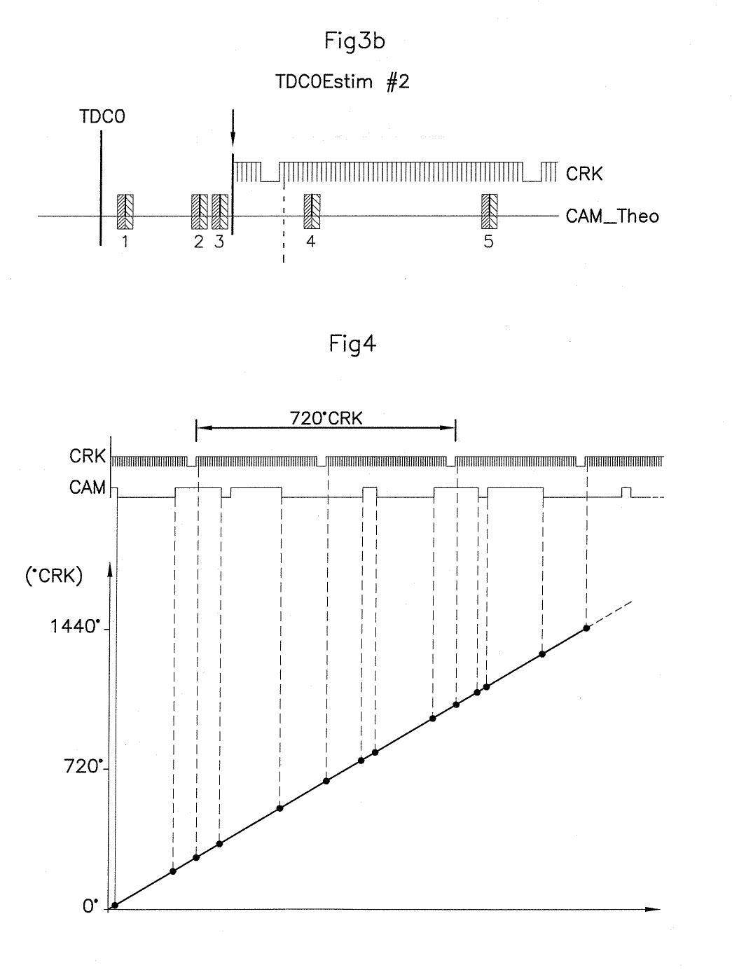

FIGS. 3a and 3b represent a third synchronization test implemented in a method according to the present invention,

FIG. 4 shows the general progress of a method according to the invention.

FIG. 1a shows the trend of the signals obtained from the position sensors of the crank shaft (curve CRK) and of the cam shaft (CAM). On the trend of the signal from the position sensor of the cam shaft, five rising edges can be seen, numbered from 1 to 5, corresponding to the particular geometry of the cam shaft target chosen in this illustrative example. The vertical arrow marks the start of the synchronization test, and the TDC0 point marks the actual position of the top dead center of cylinder 0.

FIGS. 1b and 1c show the implementation of the test for the two plausible hypotheses of TDC0 (TDC0 just after the first reference edge detected on the target attached to the crank shaft for FIG. 1b and TDC0 well before the first reference edge detected on the target attached to the crank shaft for FIG. 1c).

In FIG. 1b, it is assumed that the TDC0 has not yet passed at the moment of the start of the synchronization test, and that it will be reached after the first reference edge detected on the target attached to the crank shaft. The synchronization test starts at the vertical arrow. The rising edges detected on the target attached to the cam shaft are numbered 1, 2, 3, 4 and 5 after each estimation of TDC0. More specifically, the list of the possible edges is {1, 2, 3, 4, 5}.

When the first reference edge of the target attached to the crank shaft is detected, the last rising edges detected on the target attached to the cam shaft are determined, having been detected before said reference edge. This determination is made both by examining the theoretical trend of the signal from the position sensor of the cam shaft, shown on the curve CAM_Theo and based on the initial hypothesis taking into account the position tolerances deriving from the various uncertainties, and the trend actually observed in the facts shown on the curve CAM_Ret which here is provided with an unexpected appearance of the rising edges detected on the target attached to the cam shaft later than predicted by CAM_Theo but nevertheless within the area of uncertainty provided. It thus appears that only the edges 4 and 5 are edges that can be considered in the case of FIG. 1b given the rising edges detected on the target attached to the cam shaft. Consequently, the list is reduced to {4, 5}.

In FIG. 1c, it is assumed, by contrast, that the TDC0 is passed at the moment of the start of the synchronization test. Consequently, when the synchronization starts, at the point of the vertical arrow, the rising edges 1, 2 and 3 on the signal from the position sensor of the cam shaft are already passed, but not the edges 4 and 5. It therefore appears that only the edge 3 of the cam shaft target of the curve CAM_Ret is a possible option in this second situation.

Consequently, on completion of this first test, the situation is as follows:
for the first hypothesis concerning TDC0 (TDC0 is not yet passed at the moment of the start of the synchronization test), denoted TDC0Estim#1, the list of the rising edges detected on the target attached to the cam shaft that are plausible is reduced to {4, 5}, and
for the second hypothesis concerning TDC0 (TDC0 passed at the moment of the start of the synchronization test), denoted TDC0Estim#2, the list of the plausible cam rising edges is reduced to {3}.

Since none of the lists are empty, the two TDC0 hypotheses remain plausible at this stage. It is then necessary to wait for the next rising edge detected on the target attached to the cam shaft in order to eliminate the uncertainty on the hypotheses concerning the position of TDC0.

The invention proposes to refine the method by adding a second test and thus be able to arrive at a faster and more reliable conclusion.

FIGS. 2a and 2b show this second test performed in a method according to the invention.

It is presented in an illustrative example different from that represented in FIGS. 1a to 1c (engine start-up position and position of the edges of the target attached to the cam shaft that are different) for didactic reasons, but it is shrewd practice to use it as a complement to the first test for a given target attached to the cam shaft.

This test, called “last event test”, consists in observing a given interval, situated between a current situation and the last event detected. For each of the plausible hypotheses TDC0Estim#1 and TDC0Estim#2, a determination is made as to whether, in the list of the possible cam edges, some ought to have occurred within this interval.

Thus, in the case TDC0Estim#1, shown in FIG. 2a, the edges 4 and 5 ought to have occurred over the interval studied, situated between the vertical arrow and the first reference edge detected on the target attached to the crank shaft. Now, since no event has in fact occurred (the position of TDC0 being still, in this case, that represented in FIG. 1a—see more particularly FIG. 2b with the same example of target attached to the cam shaft), this means that the hypothesis TDC0Estim#1 is not plausible.

In the case of the hypothesis TDC0Estim#2, it is found that no edge ought to have occurred during this interval which in fact is empty. Consequently, the hypothesis TDC0Estim#2 remains the only one plausible.

In the present case, the test has made it possible to determine the real position of the top dead center TDC0 of cylinder zero, and thus to synchronize the engine.

FIGS. 3a and 3b show a third test performed in a method according to the invention. Depending on the configurations, this test may be performed after the preceding tests, for example in the case where it would not have been possible to synchronize the engine with said preceding tests.

The engine start-up position is, once again, different from those represented in FIGS. 1b and 1c on the one hand and FIGS. 2a and 2b on the other hand, and the position of the edges of the target attached to the cam shaft is also different, but the position of TDC0 is still that represented in FIG. 1a—see more particularly FIG. 3b with the same example of target attached to the cam shaft.

This test is based on the estimation, for each hypothesis of the position TDC0, of the distance between said position and the next rising edge to be detected on the signal from the position sensor of the cam shaft. Then, this distance is compared to the effective theoretical position of the rising edges of the target attached to the cam shaft.

Thus, in FIG. 3a, the estimated position of the rising edge of the cam shaft is situated at the point. Now, it is found in fact that none of the rising edges, numbered 1 to 5, appears in this estimation. Consequently, the list of the plausible rising edges for the first hypothesis, which comprised only the rising edge {5}, is now empty, which means that the hypothesis TDC0Estim#1, which was tested in this first situation, is not plausible.

On the other hand, in FIG. 3b, the same test is performed for the position TDC0Estim#2. It is found in fact that a rising edge effectively occurs at the moment estimated for number 4. Consequently, the list of the rising edges is updated: the rising edge 5 is eliminated, and the rising edge 4 is retained. Thus, the list is reduced to {4}. Since this list is not empty, this means that the hypothesis TDC0Estim#2 is plausible.

FIG. 4 shows the progress of a method according to the invention. The first graph, CRK, shows the trend of the signal from the position sensor of the crank shaft. The second graph, CAM, shows the trend of the signal from the position sensor of the cam shaft.

The horizontal arrow indicates a complete 4-stroke type engine cycle, corresponding to a rotation of 720° of the crank shaft. However, a method according to the invention is advantageous in that, unlike the existing methods, it is not looped on a 720° cycle of the crank shaft. It is thus found, on the third graph, that the angle of the crank shaft reaches values exceeding 2 revolutions of the crank shaft.

The points on this third graph correspond to the different samples, or points, on which one of the tests described previously is performed.

Such a method thus makes it possible to synchronize all the engine configurations linked to the various possible crank shaft or cam shaft target profiles, even the most complex, since the number of tests performed is not limited by the end of a cycle, and the various tests can be combined to eliminate the hypotheses one by one and come to a single plausible hypothesis, corresponding to the synchronization of the engine where the methods of the prior art would quite simply not have been able to reach a conclusion because of the high uncertainties as to the occurrence of the edges or of the edges too close together in time.

Furthermore, in the prior art methods which are limited to studying a rotation of 720° of the crank shaft after the detection of a reference edge, when the profile of the targets is such that edges of the target attached to the cam shaft are located close to these 720°, it is very difficult, even impossible, to synchronize the engine. This is not the case with a method according to the present invention which makes it possible to go beyond the limit of 720° if by any chance the engine is not synchronized before.

The present invention has been described with toothed targets, but it can be applied to any type of target, whether optical or magnetic for example. Similarly, the processing of the signals can be done without preference on the rising and/or falling edges without in any way departing from the present invention.

1. A method for synchronizing an internal combustion engine of 4-stroke type, comprising at least one cylinder comprising a piston that moves between a top dead center and a bottom dead center, the movement of the piston driving a crank shaft and a cam shaft, the method comprising the following steps:
as many plausible hypotheses as there are reference teeth present on the target attached to the crank shaft in two crank shaft revolutions are determined, concerning the position of one of the two top dead centers of the reference cylinder in the engine cycle at the moment of start up,
from the start up of the crank shaft, the passing of reference edges of a target attached to the crank shaft and of rising or falling edges of a target attached to the cam shaft is detected, each target being associated with a detector in order to produce position sensors for said crank shaft and cam shaft,
at a current position of the crank shaft from its start up, the positioning of the detected edges is used to eliminate one or more hypotheses made for the position of said top dead center of the cylinder at the moment of start up, by comparing the positioning of the detected edges with a positioning of the edges corresponding to the determined hypotheses, and
the synchronization is terminated when all the hypotheses except one have been eliminated.

2. The synchronization method as claimed in claim 1, in which, in light of the mechanical configuration of the engine and of the engine cycle, an initial list of probabilities of the edges detected on the target attached to the cam shaft is established, called CAM_PLAUS_LIST, for each hypothesis made for the position of said top dead center of the cylinder at the moment of start up.

3. The synchronization method as claimed in claim 2, comprising the following steps:
for each element of the list CAM_PLAUS_LIST, a determination is made as to whether, in the context of an engine cycle, a successive edge of the target attached to the cam shaft should occur before a reference edge of the target attached to the crank shaft,
in the case where the determination is negative, the corresponding element is deleted from the list CAM_PLAUS_LIST.

4. The synchronization method as claimed in claim 1, comprising the following steps:
a reference edge is detected on the target attached to the crank shaft,
a number of plausible hypotheses concerning the position of said top dead center in the engine cycle at the moment of start up are determined,
for each of the hypotheses, the chronology of occurrence of the edges of the target attached to the cam shaft is determined, from the list CAM_PLAUS_LIST.

5. The synchronization method as claimed in claim 4, comprising the following steps:
for each of the plausible hypotheses concerning the position of said top dead center in the engine cycle at the moment of start up, a check is made as to whether an edge should have occurred between the last edge detected on the target attached to the cam shaft and the current position,
in the case where the check proves negative, the corresponding hypothesis is eliminated.

6. The synchronization method as claimed in claim 1, in which the edges observed on the targets are the rising edges.

7. A device for synchronizing an internal combustion engine of 4-stroke type implementing the method as claimed in claim 1.

8. The synchronization method as claimed in claim 2, comprising the following steps:
a reference edge is detected on the target attached to the crank shaft,
a number of plausible hypotheses concerning the position of said top dead center in the engine cycle at the moment of start up are determined,
for each of the hypotheses, the chronology of occurrence of the edges of the target attached to the cam shaft is determined, from the list CAM_PLAUS_LIST.

9. The synchronization method as claimed in claim 3, comprising the following steps:
a reference edge is detected on the target attached to the crank shaft,
a number of plausible hypotheses concerning the position of said top dead center in the engine cycle at the moment of start up are determined,
for each of the hypotheses, the chronology of occurrence of the edges of the target attached to the cam shaft is determined, from the list CAM_PLAUS_LIST.
